(19) United States
(12) Patent Application Publication
(10) Pub. No.: US 2004/0193853 A1
(43) Pub. Date: Sep. 30, 2004

(54) Program-controlled unit

(76) Inventors: Klaus D. Maier, Biberach (DE); Dietmar Konig, Munchen (DE); Andreas Kolof, Grobenzell (DE); Albrecht Mayer, Deisenhofen (DE)

Correspondence Address: BEVER HOFFMAN & HARMS, LLP, TRI-VALLEY OFFICE, 1432 CONCANNON BLVD., BLDG. G, LIVERMORE, CA, 94550, US

(21) Appl. No.: 10/475,599

(22) PCT Filed: Apr. 9, 2002
(86) PCT No.: PCT/DE02/01295

(30) Foreign Application Priority Data
Apr. 20, 2001 (DE) 101 19 266.5

(51) Int. Cl. G06F 7/38

(52) U.S. Cl. 712/227

(57) ABSTRACT

A program-controlled unit (e.g., a microprocessor) including one or more cores and one or more peripheral component circuits connected to buses (conductive lines), and also including debug resources coupled to the buses for monitoring the transmission of trace information (e.g., selected addresses, data and/or control signals), for generating corresponding signals (e.g., the actual trace information or associated identification codes) that are output from the program-controlled unit or stored in it.

The present invention relates to a device according to the preamble of patent claim 1, i.e. a program-controlled unit having one or more cores, and having debug resources, by means of which trace information which comprises selected addresses, data and/or control signals is output from the program-controlled unit or stored in it.

Program-controlled units such as microprocessors, microcontrollers, signal processors etc., have been known in numerous embodiments for many years.

A known problem of program-controlled units is that in many cases faults which occur in them cannot be readily localized and/or remedied.

The localization and remedying of faults occurring in program-controlled units was carried out in the past, and in some cases is even carried out now, using special bond-out versions of the program-controlled units to be examined. Bond-out versions of program-controlled units differ from the standard versions of the respective program-controlled units used in mass products in that they have more input and/or output terminals, the additional input and/or output terminals being connected to locations on the program-controlled unit which are not freely accessible in the standard version of the program-controlled unit. As a result, information on internal states or processes, to be more precise usually addresses, data and/or control signals which have not been output, such as for example, but by far not exclusively, the respective current state of the program counter, can be output from the program-controlled unit and evaluated outside the program-controlled unit. By evaluating the information it is possible to trace the profile of the processes occurring within the program-controlled unit, as a result of which faults occurring in the program-controlled unit can be localized and remedied.

However, the use of bond-out versions is associated with a series of disadvantages. In particular, the bond-out versions of program-controlled units are larger and more expensive than the standard versions and, what is more important, the bond-out versions generally do not behave in precisely the same way as the standard versions.

For this reason, in some cases the procedure has been adopted of equipping program-controlled units with debug resources which extract information from the program-controlled unit which is required for localizing and remedying faults, and outputs information from the program-controlled unit, or stores in it, by means of an interface which comprises only a small number of pins and can in some cases also be used for other purposes.

Such a program-controlled unit is illustrated in FIG. 2.

The program-controlled unit which is shown in FIG. 2 is a microcontroller and comprises a core C, peripheral units P1, P2, P3 which are connected to the core C via a first bus BUS1, storage devices S1, S2, S3 which are connected to the core C via a second bus BUS2, debug resources DR which are connected to the core C, and an interface SS which is assigned to the debug resources DR and via which the debug resources DR output data which is to be output to an external device and via which the debug resources DR are controlled by the external device.

The peripheral units P1 to P3 are, for example, an A/D converter, a timer, a coder, a compression device, a CAN interface or other units which can be integrated into microcontrollers, and the storage devices are, for example, a RAM, a ROM and a flash memory.

The debug resources DR are preferably capable of outputting what is referred to as trace information. For this purpose, the debug resources DR monitor for conditions which can be predefined from outside the program-controlled unit occurring within the core of the program-controlled unit and whenever the condition or one of the conditions is fulfilled, addresses, data and/or control signals which can be predefined from outside the program-controlled unit are output from the program-controlled unit without interrupting the operation of the program-controlled unit. As a result it is possible, for example, but by far not exclusively possible, for the debug resources DR to output the data which is then fed to the core from the program-controlled unit whenever the core wishes to read data from a specific address or a specific address area.

In general, the debug resources DR also carry out further actions which are necessary or helpful for localizing and remedying faults which occur in the program-controlled unit. As a result, the debug resources DR are, for example, capable of stopping the program-controlled unit when specific conditions occur, for example when a specific program counter reading is reached, and reading out or changing the contents of registers of interest.

Such debug resources, also referred to as OCDS modules, are known, so further details will not described.

Owing to the increasing significance of the presence of debug resources in program-controlled units, a standard which is referred to as “The Nexus 5001 Forum Standard for a Global Embedded Processor Debug Interface” was defined for the interface (interface SS) in 1999 by the IEEE Industry Standards and Technology Organization (IEEE-ISTO), by means of which interface the debug resources can exchange data particularly efficiently with a device which is provided outside the program-controlled unit, for example with a debug control unit or emulation control unit, or with a measuring device such as, for example, a logic analyzer.

The debug resources and the NEXUS interface make it possible to detect and remedy faults occurring in program-controlled units with a relatively small amount of expenditure.

This applies however only to program-controlled units which are of simple design. In more complex program-controlled units, in particular in program-controlled units with a plurality of cores, the cost which has to be met to provide debug resources rises greatly. This is due, inter alia, to the fact that separate debug resources have to be provided for each core.

The present invention is therefore based on the object of finding a possible way of localizing and remedying faults occurring in the program-controlled unit using debug resources which are of small and simple design and can be operated easily.

This object is achieved according to the invention by means of the program-controlled unit claimed in patent claim 1.

The program-controlled unit according to the invention is characterized by the fact that the debug resources comprise one or more components which are connected to lines which run between the cores and/or individual components, a plurality of components or all the other components of the program-controlled unit and which can output, from the program-controlled unit, addresses, data and/or control signals which are selected from the addresses, data and/or control signals transferred via these lines, or can store them in said unit.

As a result it becomes considerably easier to examine the addresses, data and/or control signals which are transferred between the cores and/or individual components, a plurality of components or all the other components of the program-controlled unit.

In conventional debug resources, i.e. in debug resources which are connected exclusively to the at least one core of the program-controlled unit, this requires a considerably higher degree of expenditure: it is possible to determine, from the states prevailing within the cores and the processes occurring within them, whether, and if so which, addresses, data and/or control signals are transferred between the components of the program-controlled unit. This is more complicated because considerably larger quantities of data are transferred within the core per time unit than via the lines (buses) connecting the components of the program-controlled unit, and because it is necessary to determine, by the evaluation of a plurality of signals, whether, and if so which, data is outputted and received by the core.

The debug resources of the program-controlled unit according to the invention can thus be constructed more simply and operated more easily than is the case with conventional debug resources.

Furthermore, the debug resources according to the invention make it possible to monitor not only data transfers from and to the cores but also data transfers between other components of the program-controlled unit. This is not possible with conventional debug resources.

The debug resources of the program-controlled unit according to the invention are even more powerful than conventional debug resources despite the simpler design and the easier operation of the program-controlled unit.

Advantageous forms of the invention can be found in the subclaims, the following description and the figures.

The invention is explained in more detail below by means of exemplary embodiments and with reference to the figures, in which:

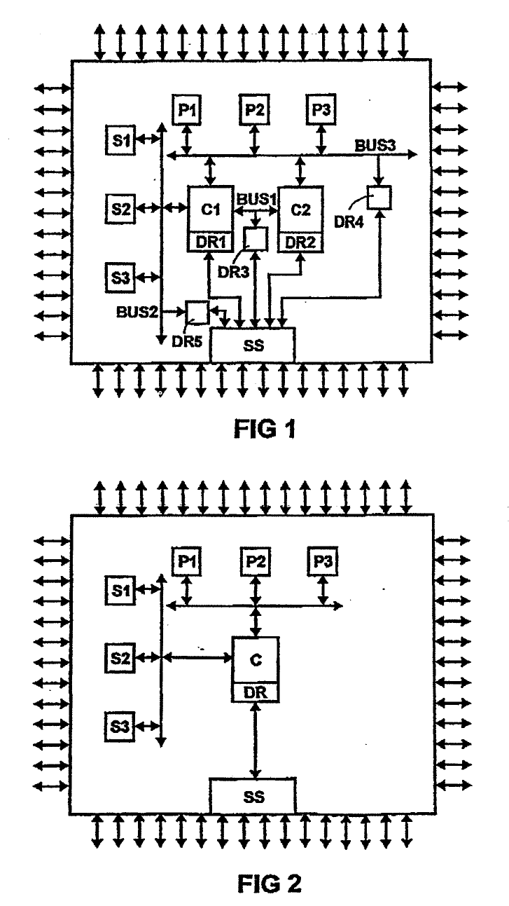

FIG. 1 shows the design of the program-controlled unit which is described in more detail below, and

FIG. 2 shows the design of the conventional program-controlled unit which is described at the beginning.

The program-controlled unit which is described below is a microcontroller. The peculiarities of the microcontroller which are described below, to be more precise the peculiarities—described below—of the debug resources provided therein can also be used with any other desired program-controlled units.

The program-controlled unit which is described below is illustrated schematically in FIG. 1. For the sake of completeness it is to be noted that only the components of the program-controlled unit which are of particular interest are shown and described.

The programme control unit which is shown in FIG. 1 comprises a first core C1, a second core C2, peripheral units P1, P2 and P3 which are connected to the cores C1 and C2 via a first bus BUS1, storage devices S1, S2 and S3 which are connected to the cores C1 and C2 via a second bus BUS2, a third bus BUS3 which connects the cores C1 and C2 to one another, debug resources DR1 to DR5, and an interface SS via which the debug resource components DR1 to DR5 output data which is to be output to an external device, and via which the debug resource components DR1 to DR5 are controlled by the external device.

The components of the program-controlled unit which are referred to with the same reference symbols as the components contained in the program-controlled unit according to FIG. 2 are identical or components which correspond to one another.

The interface SS is an interface which is constructed according to the NEXUS standard mentioned at the beginning, but could also be a different interface, for example a JTAG interface.

The actual peculiarity of the program-controlled unit under consideration are the debug resources which are formed by the components DR1 to DR5.

Of these debug resource components

the debug resource component DR1 is connected to the first core C1,

the debug resource component DR2 is connected to the second core C2,

the debug resource component DR3 is connected to the first bus BUS1,

the debug resource component DR4 is connected to the second bus BUS2, and

the debug resource component DR5 is connected to the third bus BUS3.

The debug resource components DR3 to DR5 which are connected to the buses BUS1 to BUS3 monitor the addresses, data and/or control signals which are transferred via the respective buses. To be more precise, they check whether the transferred data fulfills the specific conditions, for example whether an address which is transmitted via the bus corresponds to a predefined address or lies within a predefined address area. The conditions are prescribed via the interface SS by means of a control device which is provided outside the program-controlled unit. If one of the debug resource components DR3 to DR5 determines that a condition whose occurrence it has to monitor has occurred, it reacts in a way which is prescribed from outside the program-controlled unit via the interface SS. The reaction may include outputting specific data to the interface SS, which data is transmitted simultaneously or at a specific earlier time or at a specific later time via the assigned bus. The reaction can additionally or alternatively comprise a message to one debug resource component, a plurality of debug resource components or all the debug resource components, by means of which message it is signaled to the respective debug resource components that a condition which it has to monitor has occurred. The other debug resource components react to such a message in a way which is prescribed via the interface SS from outside the program-controlled unit. This reaction may include the respective debug resource component outputting specific data to which it has access to the interface SS, or carrying out other specific actions, for example stopping the core to which it is assigned. The reaction may also be made dependent here on the fulfillment of one or more further conditions, it being possible for the occurrence of these conditions to be monitored via the respective debug resource component itself or by another debug resource component.

Due to the fact that the debug resource components DR3 to DR5 track the addresses, data and/or control signals transferred via the buses, and where necessary output them to the interface SS, the other debug resource components DR1 and DR2, i.e. the ones which are assigned to the cores C1 and C2, can be of considerably simpler design than was previously the case. Their function can be restricted to monitoring, and influencing the instructions which are executed in the respective core, and/or outputting to the interface SS data which is related to the instructions or to the program sequence; it may already be sufficient here if the current state of the programme counter is monitored and output to the interface SS where necessary.

As a result, the design of the debug resources of the program-controlled unit can be considerably simplified. Although the debug resources comprise a larger number of components than would be the case if, as previously, only debug resource components connected to the cores were provided, this plurality of debug resource components are of considerably simpler design.

The debug resource components DR3, DR4 and DR5 which are connected to the buses BUS1, BUS2 and BUS3 can be of much simpler design in comparison with debug resource components which determine the addresses, data and/or control signals transmitted via the buses by observing the states prevailing and processes occurring within the core, because the quantity of data which is transmitted via one of the buses per time unit is considerably smaller than the quantity of data which is transmitted per time unit within the cores and has to be observed in order to determine the data transmitted via the buses.

The debug resource components DR1 and DR2 which are connected to the cores C1 and C2 can be of simpler design than previously because owing to the provision of the debug resource components DR3, DR4 and DR5 there is no longer any need to determine, from the processes occurring in the cores C1 and C2, the data transfers between the cores and/or the other components of the program-controlled unit.

Irrespective of this, faults which occur in the program-controlled unit can be even better localized and remedied by the debug resources described above than was possible with previous debug resources. In particular, it is thus also possible to observe data transfers between peripheral units and/or storage devices, something which was not possible when there was a single observation of the states prevailing and processes occurring in the cores.

It should be noted that the present description of the function and the cooperation of the debug resource components is to be considered only as exemplary. The debug resource components can also have any further or other desired functions and/or cooperate differently.

Irrespective of this, it is possible to provide for the debug resource components which are present, or for further debug resource components, to be connected to the peripheral units, the storage devices or other components of the program-controlled unit (for example to bus controllers which control the allocation of buses) and to observe and influence the states prevailing or processes occurring therein and/or output data representing the states or processes to the interface SS.

It should also be noted that the use of the described debug resources proves advantageous even with program-controlled units with more or fewer than two cores and/or with more or fewer and/or other components and buses.

Irrespective of this, it is also possible for the data which is output by the debug resource components not to be output immediately via the interface SS from the program-controlled unit but rather to be stored within the program-controlled unit until it is retrieved from the external device for which this trace information is intended.

As a result of the described core-specific program trace and bus-specific data trace, the debug resources of the program-controlled unit can be of simpler design irrespective of the details of the practical implementation and can be operated more easily than is the case with conventional debug resources, and the debug resources are even more powerful than conventional debug resources despite the simpler design and the easier operation.

List of Reference Symbols

BUSx Buses

Cx Cores

DRx Debug resources

Px Peripheral units

SS Interface

Sx Storage devices

1. A program-controlled unit having one or more cores (C1, C2), and having debug resources (DR1-DR5), by means of which trace information comprising selected addresses, data and/or control signals is output from the program-controlled unit or stored in it, characterized in that the debug resources (DR1-DR5) comprise one or more components (DR3-DR5) which are connected to lines (BUS1-BUS3) running between the cores (C1, C2) and/or individual components, a plurality of components or all the other components (P1-P3, S1-S3) of the program-controlled unit and which can output, from the program-controlled unit, addresses, data and/or control signals selected from the addresses, data and/or control signals transferred via these lines, or store them in it.

2. The program-controlled unit as claimed in claim 1, characterized in that the components (DR3-DR5) of the debug resources (DR1-DR5) which are connected to the lines (BUS1-BUS3) running between the cores (C1, C2) and/or individual components, a plurality of components or all the other components (P1-P3, S1-S3) of the program-controlled unit can be checked to determine whether the addresses, data and/or control signals transferred via the lines fulfill certain conditions.

3. The program-controlled unit as claimed in claim 1 or 2, characterized in that the components (DR3-DR5) of the debug resources (DR1-DR5) which are connected to the lines (BUS1-BUS3) running between the cores (C1, C2) and/or individual components, a plurality of components or all the other components (P1-P3, S1-S3) of the program-controlled unit can determine whether, and if so which, of the addresses, data and/or control signals which are transferred via the lines are to be output from the program-controlled unit or stored in it.

4. The program-controlled unit as claimed in one of the preceding claims, characterized in that the components (DR3-DR5) of the debug resources (DR1-DR5) which are connected to the lines (BUS1-BUS3) running between the cores (C1, C2) and/or individual components, a plurality of components or all the other components (P1-P3, S1-S3) of the program-controlled unit can cause addresses, data and/or control signals transferred via the lines to be output from the program-controlled unit or stored in it.

5. The program-controlled unit as claimed in one of the preceding claims, characterized in that the debug resources (DR1-DR5) comprise further components (DR1, DR2), these further components (DR1, DR2) being connected to the cores (C1, C2), and these further components examining and influencing selected states or processes in the cores and/or outputting data representing these states or processes from the program-controlled unit or storing it in it.

6. The program-controlled unit as claimed in claim 5, characterized in that the selected states and processes are states and processes from which it is possible to determine which instructions the cores (C1, C2) are carrying out at a particular time.

7. The program-controlled unit as claimed in claim 5 or 6, characterized in that the selected states or processes are exclusively states and processes from which it is possible to determine which instructions the cores (C1, C2) are carrying out at a particular time.

8. The program-controlled unit as claimed in one of the preceding claims, characterized in that the debug resources (DR1-DR5) comprise components, these components being connected to the other components (P1-P3, S1-S3) of the program-controlled unit, and these debug resource components examining and influencing selected states and processes in the other components of the program-controlled unit and/or outputting data representing these states or processes from the program-controlled unit or storing it in it.
